(19) United States
(12) Patent Application Publication
(10) Pub. No.: US 2005/0188468 A1
(43) Pub. Date: Sep. 1, 2005

(54) Multifunctional pliers

(76) Inventor: Bruce A. Crawford, Cookeville, TN (US)

Correspondence Address: LOCKE LIDDELL & SAPP LLP, 600 TRAVIS, 3400 CHASE TOWER, HOUSTON, TX, 77002-3095, US

(21) Appl. No.: 10/979,666

(22) Filed: Nov. 2, 2004

Related U.S. Application Data
(60) Provisional application No. 60/516,987, filed on Nov. 4, 2003.

(51) Int. Cl. B25F 1/00

(52) U.S. Cl. 7/107

(57) ABSTRACT

Several embodiments of an improved multifunction hand tool, such as electricians' pliers 10 are disclosed. The hand tool may comprise one or more of: a deburring section 34; a bore 28 for bending wire; sheath stripping die 37, 41; conductor insulation stripping die 33, 37, 43, 46; wire cutter 38; and shaped notch 42 for holding objects.

### CROSS-REFERENCE TO RELATED APPLICATIONS

This application claims the benefit under 35 U.S.C. § 119(e) of U.S. Provisional Application No. 60/516,987, filed with the U.S. Patent and Trademark Office on Nov. 4, 2003, and titled “IMPROVEMENTS TO ELECTRICAL HAND TOOLS,” the disclosure of which is incorporated herein by reference in its entirety.

### BACKGROUND OF THE INVENTION

1. Field of the Invention

The present disclosure relates to hand tools, more particularly multi-functional pliers.

2. Technical Background

The use of pliers for a variety of functions in wiring and other electrical applications is well known, and a large number of specialized pliers tools have been developed for such applications. Most familiar among these are long nose pliers, particularly needle nose pliers, which have highly tapered tips for grasping wires and other small objects in confined spaces and square-nosed side cutting or “linesman's” pliers, which typically have broad gripping surfaces. Somewhat less common are so-called “duckbill” pliers, in which the jaws are highly tapered in the plane of the handles but are significantly less tapered in the plane of the gripping surfaces, thus providing a pair of broad, flat tips. All three of these pliers types generally incorporate a set of wire cutting blades in the jaws near the pivot between the jaws. End cutting pliers and wire stripping pliers, which are configured with one or more sets of half-round dies for removing insulation from wires of various diameters, are also well known.

It is also well known that electricians often prefer to carry as few tools as possible while maintaining the ability to perform the full range of wiring operations. Consequently, a number of attempts have been made to produce pliers tools incorporating additional features or combining features of standard pliers and stripping pliers. For example, U.S. Pat. No. 4,735,117 discloses a linesman's pliers modified to provide a pair of adjustable stripping jaws along one side of the pliers. Similarly, U.S. Pat. No. 3,947,904 discloses a linesman's pliers in which one face of the jaws has been thickened to form a hammerhead and several wire-stripping dies are provided at the tip of the jaws. U.S. Pat. No. 4,953,248 also discloses combination pliers that incorporate a wire cutter, bolt cutters, a hammerhead, several stripping dies, a crimping die for terminal connectors, a screwdriver, and other features. U.S. Pat. Nos. 5,323,502, 6,588,039, and 6,691,403 disclose stripping/crimping tools that include specialized stripping dies for Romex-type cable sheaths. Finally, U.S. Pat. No. 6,029,297 discloses combination pliers that incorporate cutters, crimping and stripping dies, and wire curl holes for forming loops in the ends of wire leads for connection to screw terminals. A number of other similar tools are disclosed in the art. Nevertheless, there remains a need for a multifunctional hand tool that combines the functions of greatest interest to the user, such as an electrician, in a single convenient device. A number of hand tools satisfying this need are disclosed herein.

### SUMMARY OF THE INVENTION

In one aspect, the present invention comprises a pliers tool of the type having a pair of pivotally joined pliers arms each including a handle portion at one end and a jaw portion at another end. The jaw portions have outer surfaces and opposed complementary gripping surfaces such that the jaw portions together define at least one elongated groove in one of the outer surfaces along the complementary gripping surfaces. The jaw portions may further comprise at least one pair of opposed tool mounts intersecting the groove (one tool mount on each of the jaw portions) and adapted to operate on an object in the groove when the jaw portions are closed together. In certain embodiments, the pliers may incorporate a groove and tool mounts on each side. In certain long-nose pliers embodiments, the pliers jaw portions may be tapered toward their tips to form a needle-nose or duckbill pliers. In some such embodiments, the gripping surfaces include a notch near the tip of each jaw portion for grasping an object there between.

In another aspect, the invention comprises a pliers tool, which may have a pair of pliers arms each having a handle portion at one end and a jaw portion at another end, the arms being pivotally joined together at a point on each arm between their respective jaw and handle portions. Each of the jaw portions is tapered toward a tip remote from the pivot point. The jaw portions have outer surfaces and opposed and may have complementary gripping surfaces, and the jaw portions together may define at least one elongated groove in an outer surface thereof along the complementary gripping surfaces. The jaw portions may further comprise at least one pair of opposed wire strippers intersecting the groove (one wire stripper on each jaw portion) for removing insulation from a wire in the groove when the jaw portions are closed together. In an especially preferred embodiment, the tool includes a second elongated groove on another outer surface of the tool and a second pair of wire strippers that are adapted to remove insulation from wire of a different diameter than the first wire strippers.

Another embodiment may comprise a pair of pliers arms each comprising a handle portion at one end and a jaw portion at another end, the arms being pivotally joined together at a point on each arm between their respective jaw and handle portions. The pair of pliers arms comprise an outer surface; and the jaw portions comprise at least a first pair of opposed tool mounts. One of the pair of tool mounts is disposed on each of the jaw portions, and the tool mounts are adapted to operate on an object disposed between the tool mounts when the jaw portions are closed together. The first pair of opposed tool mounts may comprise at least one wire-stripping tool; and the first pair of opposed tool mounts may be disposed perpendicular to the pair of pliers arms for removing the insulation from an insulated electrical wire using a pulling motion.

Another embodiment may comprise a pair of pliers arms having a deburring portion on the outer surface of the jaw portion to remove burrs from a material, such as the inside edges of a pipe. The deburring portion may comprise a sharpened edge and/or a rounded, roughened face.

Another embodiment may comprise pliers arms having at least one bore in at least one of the outer surfaces and wherein the bore may be blind and have a predetermined diameter and depth to allow wire to be seated in the bore and bent around a portion of the pliers to form a loop. The pliers tool may further comprise at least one wire stripping die disposed on an outer surface. The stripping die may comprise a half-circle wire-stripping die.

Another embodiment may comprise a wire stripping tool in the shape of a Romex-type non-metallic 2 conductor wire with ground cable sheath, wherein the stripping tool may remove the cable sheath without damaging the insulation of the wires inside the multi-conductor wire cable sheath. Another embodiment of the present invention may comprise one or more wire stripping tool to remove the insulation of multiple same-size wire conductors using an in-line pulling motion. Another embodiment of the present invention may comprise a first wire stripping tool for stripping the sheath of a Romex-type non-metallic 2 conductor wire with ground cable and a second wire stripping tool for removing the insulation of multiple same-size wire conductors using an in-line pulling motion.

Another embodiment may comprise a pliers tool having a cutting area in the center area of the jaw portion and parallel with the pliers arms.

Another embodiment may comprise a pliers tool having a pair of pliers arms each comprising a handle portion at one end and a jaw portion at another end, the arms being pivotally joined together at a point on each arm between their respective jaw and handle portions. The pliers arms comprise an outer surface. A wire-stripping tool may be disposed on the outer surface of the pliers arms in the proximity of the pivot point and parallel to the pair of pliers arms for removing the insulation from an insulated electrical wire using an out-of-line motion.

Other embodiments of the invention may comprise a pair pliers tool shaped in the form defined as needle nose pliers, side cutting linesman pliers, diagonal pliers, nippers, or wire strippers pliers, and having one or more of the features summarized above

### BRIEF DESCRIPTION OF THE DRAWINGS

FIG. 1 depicts an exemplary pliers tool according to the present disclosure with its jaws in a closed position.

FIG. 2 depicts the exemplary pliers tool of FIG. 1 with the jaws in the open position.

FIG. 3 depicts the exemplary pliers of FIG. 1 from the other side.

FIG. 4 depicts a stripping die and a wire cutting area according to the present invention.

FIG. 5 depicts multiple stripping dies according to the present invention.

FIG. 6 depicts a stripping die according to the present invention.

FIG. 7 depicts a stripping die and bores for bending wire according to the present invention.

FIG. 8 depicts a deburring section on a hand tool according to the present invention.

FIG. 9 depicts a notch on a pliers tool according to the present invention.

FIG. 10 depicts a half-circle wire-stripping die according to the present invention.

FIG. 11 depicts another stripping station on a hand tool according to the present invention.

FIG. 12 depicts a pliers tool configured to remove insulation according to the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is intended to cover all modifications, equivalents and alternatives falling within the scope of the invention as defined by the appended claims.

### DESCRIPTION OF ILLUSTRATIVE EMBODIMENTS

One or more illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. In general, the present invention is directed to a number of improvements to hand tools, such as electrician's pliers, comprising tools, dies or other devices for: removing insulation or sheath from a conductor or cable; cutting wire; bending a loop in wire; turning of nuts, bolts, locknuts, and receptacle yokes; and/or removing of burrs from conduit or pipe. The types of hand tools that may benefit from the present invention include, but are not limited to, side cutting pliers (sometimes known as “linesman” pliers), end cutting pliers, long nose pliers, diagonal pliers and wire strippers of all types and designs. One or more of the following improvements may be incorporated into the design of existing hand tools in any combination desired to make a multifunctional hand tool according to the present invention.

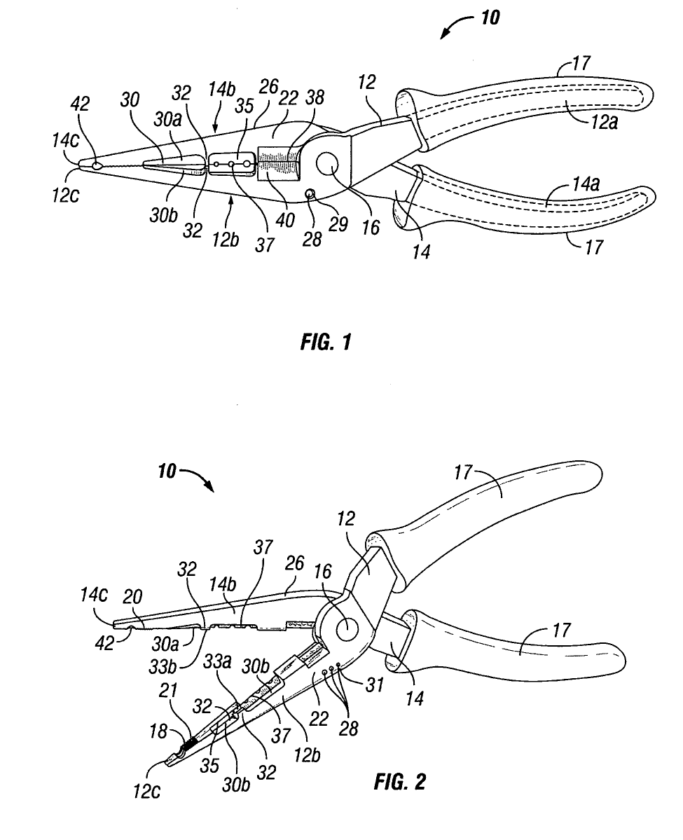

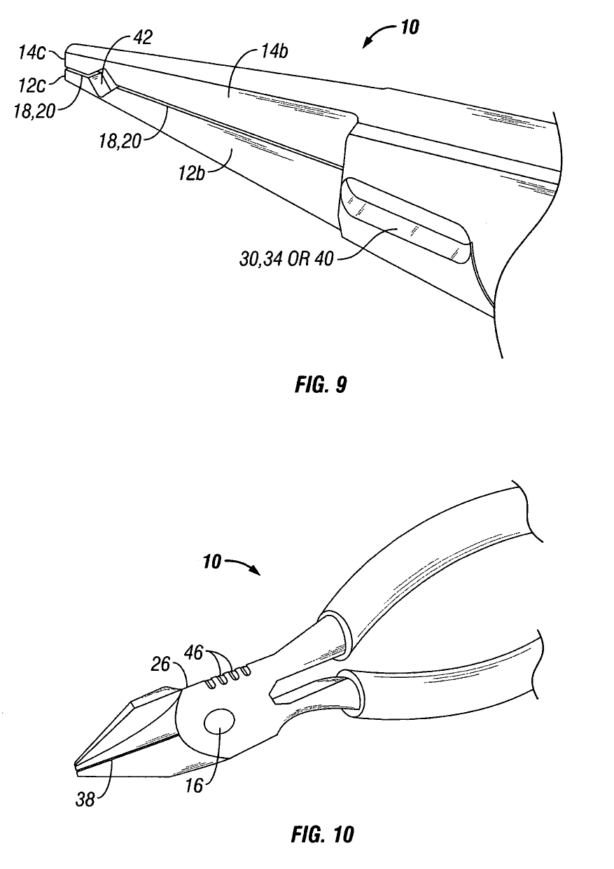

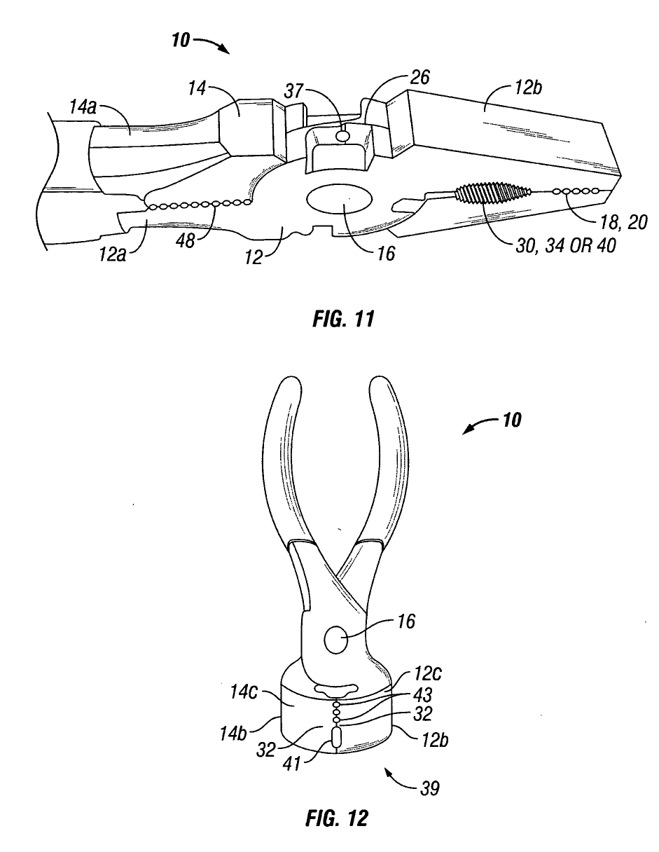

A multifunctional hand tool according to the present disclosure may comprise one or more of: (i) a set of upper and lower stripping dies to allow removal of the insulation from the conductor (see, e.g., FIGS. 1-7 and 11-12). (ii) a deburring section allowing the user to, among other things, place the tool head into the end of a conduit or pipe and remove any burrs from the inside edges (see, e.g., FIG. 8). (iii) one or more “V”-shaped, rectangular-shaped or other type notch on the working end of a hand tool to allow the user to easily hold or turn objects, such as bolts, locknuts, and receptacle yokes (see, e.g., FIGS. 1-3 and 9); (iv) one or more holes to allow different size wires to be inserted to a predetermined depth and then bent to form a loop. (see FIGS. 1, 2, and 7). (v) one or more half-circle stripping dies to facilitate stripping of insulation from wires by placing the wires between the edge and one's thumb (see, e.g., FIG. 10). (vi) multiple stripping dies on the hand tool where little or no work is usually performed, such as between the tips and the wire cutting area of a needle nose pliers (see, e.g., FIGS. 1-5 and 10 ) (vii) a wire cutting area in the center area of the tool instead of on the side (see, e.g. FIGS. 1-5 and 9). (viii) a wire stripping station that allows the conductor to stay intact while cutting the insulation (see FIG. 11). (ix) an insulation sheath stripping die for what is commonly called Romex non-metallic 2 conductor with ground cable for stripping the outer jacket without damaging the insulation of other wires inside the jacket (see, e.g. FIG. 12). (x) a multiple same-size stripping station for stripping more than one wire at a time from multi-connector wire cables (see, e.g., FIG. 12).

Turning now to more specific descriptions of particular embodiments of the present invention, FIGS. 1, 2 and 3 depict a pliers-type hand tool 10 according to the present invention. The tool 10 comprises generally of two pliers arms 12, 14 pivotally joined by a rivet at a pivot point 16. Each of the pliers arms 12, 14 may include a handle portion 12a, 14a and a jaw portion 12b, 14b ending in a tip portion 12c, 14c. The handle portions 12a, 14a may be provided with handle grips 17, preferably made of an elastomeric material that provides a sufficient amount of insulation (electrical, thermal, vibration or otherwise) between the arms 12, 14 and the hand of the user (not shown). As illustrated more clearly in FIGS. 2, 4-6 and 11, jaw portions 12b, 14b may define opposed complementary gripping surfaces 18 and 20 on the inside faces of the jaw portions. The gripping surfaces may also include a friction enhancing structure 21 for improved gripping of objects, such as teeth.

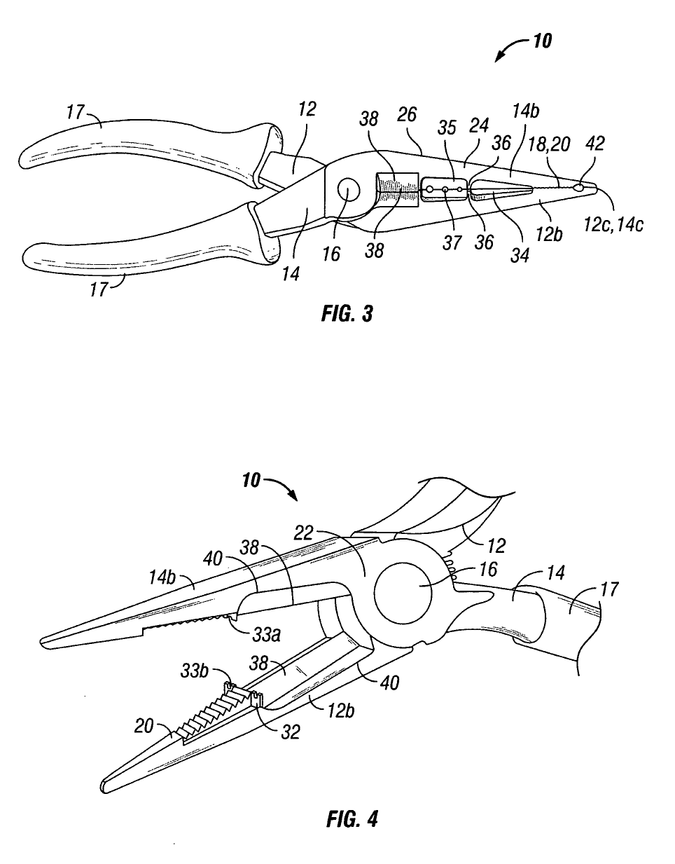

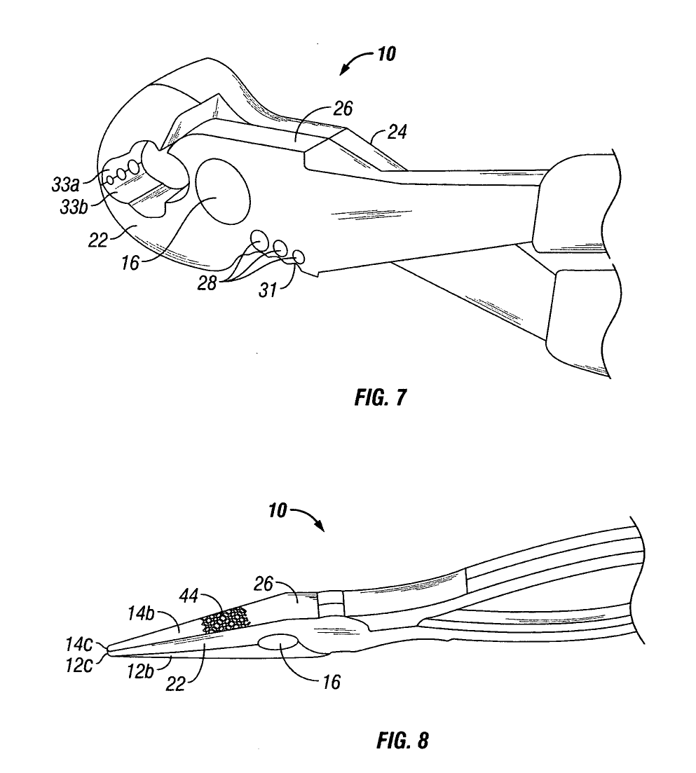

Referring to FIGS. 1 and 3, when jaw portions 12b, 14b are closed together a common outer surface is defined that includes side surfaces 22, 24, and top surface 26. For duckbill pliers embodiments according to the present invention, top surface 26 may be substantially flat and may decrease in width slightly, or not at all, toward the tips 12c, 14c. In long nose pliers embodiments, such as the needle-nose pliers shown in FIGS. 1-3, top surface 26 may be more rounded and may decrease significantly in width toward the jaw tips 12c, 14c. It will be appreciated that many other types of hand tools may benefit from the present disclosure including, but not limited to, linesman pliers (see, e.g., FIG. 6), combination jaw with cutters pliers (sometimes called fencing pliers) (see, e.g., FIG. 11), diagonal pliers (see, e.g., FIG. 10), nipper or end cutting pliers (see, e.g., FIGS. 7 and 12), and wire stripper pliers.

Referring to FIGS. 1, 2 and 7, each of side surfaces 22, 24 may incorporate one or more bores 28; preferably a blind bore of predetermined depth and diameter. As depicted in FIGS. 1, 2, and 7, the distance from the bore 28 to the top surface 26 may vary depending on the diameter of the wire. For example, a larger wire diameter may require a shorter distance from the bore 28 to the top surface 26. Each bore 28 may be configured to receive the stripped end portion of a wire or conductor. Each bore 28 may be countersunk or slightly tapered 29 (FIG. 1) near the surface. With the conductor end portion seated in the bore, the conductor may then be bent along surfaces 22, 24, and/or 26 to create a conductor loop suitable for connection to a screw terminal or the like. One or more of the surfaces 22, 24, and 26 may have a relief 31 (FIGS. 2 and 7) for the conductor to form a smoother bend when wrapped along the surfaces 22, 24 and/or 26. The depth of each bore 28 may be selected to provide a loop of optimal proportions for a standard screw terminal. Preferably the bores 28 in surfaces 22 and/or 24 are sized for different wire diameters.

Side surface 22 may incorporate an elongated depression or groove 30. It will be appreciated that groove 30 actually comprises complementary grooves 30a and 30b running longitudinally along the side surface 22 on jaw portions 12b, 14b, respectively, adjacent to gripping surfaces 18 and 20. As illustrated in FIGS. 1, 2 and 6, the groove 30 may be intersected by a pair of tool mounts 32 that are adapted to operate on an object disposed within the groove 30. The tool mounts 32 may be disposed perpendicular to the is pliers jaws 12b and 14b and may provide a specific tool, die or device for accomplishing a specific task. Preferably, a round wire-stripping die 33 (comprising portions 33a and 33b) may be located on tool mounts 32 such that the die 33 can be closed about an insulated conductor to cut through the insulation thereon, after which the conductor and/or the pliers may be pulled longitudinally (i.e., in-line with the pliers handles) to remove the insulation from a portion of the conductor. See FIGS. 2, 4, 6 and 7. FIG. 12 illustrates application of this aspect of the invention to a different type of hand tool. A pair of tool mounts 32 may be disposed on the tips 12c, 14c of end-cutting pliers jaws 12b, 14b. It will be appreciated that other types of tools, dies or devices, such as cutting and crimping tools may be provided on one or more of tool mounts 32 in place of or in addition to the stripping die 39. Although not shown in FIG. 12, end-cutting pliers 10 may retain a wire cutter 38 in addition to incorporating one or more of the various tools, dies or devices of the present invention.

In a particularly preferred embodiment illustrated in FIGS. 1-3, side surface 24 is likewise provided with a depression or groove 34 and a pair of tool mounts 36 that may be adapted to strip wire of a different diameter than the dies on tool mounts 32. In certain cases it may be possible and/or desirable to incorporate more than one stripping die in tool mounts 32, 36 to provide for stripping multiconductor cables or conductors of different diameters. Alternately, one or more crimping dies, or one or more other tools, dies or devices may be incorporated. In another embodiment, wire-stripping die 33 may cooperate with the end of groove 30, 34 to provide a predetermined length of stripped wire. In other words, a user may insert an insulated conductor into hand tool 10 such that the conductor end contacts the end of groove 30, 34 thereby providing a fixed length of insulation to be removed by the wire-stripping die 33. Alternately, a pedestal or other stop may be provided in groove 30, 34 to determine the length of insulation to be removed by wire stripping die 33.

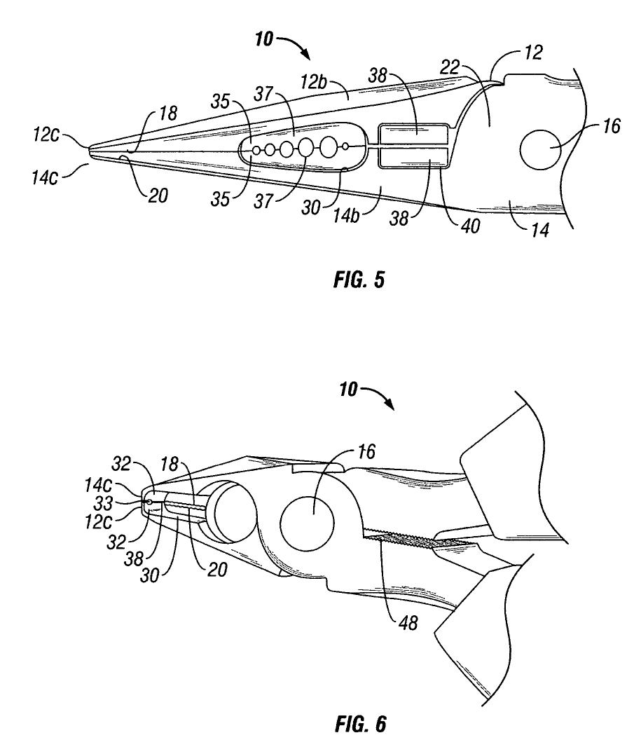

In certain alternative embodiments, grooves 30, 34 may contain one or more tool mounts 35 oriented substantially in line with the pliers arms 12, 14. As described above for the tool mounts 32, 36, one or more tools, dies or other devices may be located thereon. For example, as shown in FIG. 5 wire stripping dies 37 allow insulation to be removed from a wire that is placed between the jaw portions 12b, 14b, such that the wire is oriented substantially perpendicular to the length of the tool 10. One or more of wire stripping dies 33, 37 may be configured to remove insulation simultaneously from the conductors of a multi-conductor cable, such as a two-wire or three-wire Romex cable. As shown in FIG. 12 for end-cutting pliers, the wire-stripping die 39 may be configured to remove the outer sheath as well as conductor insulation from a Romex-type-non-metallic conductor cable. A first die portion 41 may be configured to remove the outer sheath for cutting and removing the cable sheath without damaging the insulation of the wires inside the sheath. Second die portion 43 may be configured to allow removing the insulation from the multiple same-size wire conductors in the Romex cable. In one embodiment, the hand tool 10 may be configured as depicted in FIG. 12 wherein the stripping die 41 for the sheath and the wire-stripping die 43 for the multiple same-size wire conductors are disposed side by side adjacent the tips 12c, 14c. In another embodiment, the hand tool 10 may be configured wherein the stripping die for one size sheath and the stripping die for another size sheath are side by side. Also, the hand tool 10 may comprise one or more sheath stripping dies 41 and one or more wire stripping dies 43 for different size or gauge of wire.

As shown in FIGS. 1-6 and 10, tool 10 preferably incorporates at least one set of wire cutters 38 as is typical of electricians' pliers comprising, typically, a plurality of blades or a single blade and an anvil. Preferably the cutter 38 is placed on or close to side surface 24 and as closely as possible to pivot point 16. In another embodiment, as depicted in FIGS. 4 and 5 the wire cutter blades 38 may form a cutting area in the center area of the jaw portion 12b, 14b of the pliers arms 12, 14 with the cutting area parallel with the pliers arms 12, 14. A recess 40 may be provided in side surface 22 that extends through the jaw portions to the cutting blades 38 to provide access to the blades. In addition to the cutter blades, or in place of them, tool 10 may include a stripping die for stripping multi-conductor cable in recess 40 similar to that described for groove 30, 34.

Turning to FIGS. 1-3 and 9, jaw portions 12b, 14b of tool 10 also preferably include a pair of opposed notches 42, preferably oppositely shaped notches, such as “V” or rectangular notches, adjacent the gripping surfaces 18, 20 and a predetermined distance from tips 12c 14c. These notches provide improved gripping and manipulation of objects, such as fasteners and other things. Preferably, the notches 42 are at least 3/16″ from the tips 12c, 14c so that there remains useful gripping surfaces 18, 20 at the very tip of the tool.

As shown in FIG. 8, one or more of the outer surfaces 22, 24, 26 of jaw portions 12b, 14b of pliers 10 may comprise a deburring tool 44 for electrical conduit and other materials. For example, in a duckbill pliers embodiment, such as shown in FIG. 8, a sharpened edge may be provided where side surface 22 meets top surface 26 to provide a deburring tool for deburring conduit. In a needle-nose pliers embodiment, where there is no well-defined edge between the top and side surfaces, a portion of one or both top surfaces 26 may be roughened, sharpened and/or provided with a layer of abrasive material (similar to a half-round file) to assist in deburring operations.

Turning now to FIG. 10, pliers 10 may also include one or more additional half-circle wire stripping dies 46 disposed, for example, on an edge of outer surface 26 close to pivot 16. A user may remove insulation form a wire by pressing the insulated wire into one of the dies and then manually rotating the wire relative to pliers 10 (or vice versa) to completely cut through the insulation and then pulling the wire (or the pliers) to separate the portion of the insulation from the conductor. Alternately, the user may press the wire into the die thereby cutting through half the insulation and then pulling the wire (or the pliers) to remove the insulation.

As illustrated in FIG. 11, another embodiment of the present invention includes a pliers tool 10 that comprises a pair of pliers arms 12, 14 each comprising a handle portion 12a, 14a at one end and a jaw portion 12b, 14b at another end. The arms are pivotally joined together at a point 16 on each arm between their respective jaws and handle portions. The pair of pliers arms 12, 14 comprise a top surface 26. A wire-stripping tool 37 may be disposed on the outer surface of the pliers arms 12, 14 in the proximity of the pivot point 16 and parallel to the pair of pliers arms 12, 14 for removing the insulation from an insulated electrical wire using a pulling motion normal to the length of the tool.

Also shown in FIGS. 6 and 11, is hand tool portion 48. It will be appreciated by those of ordinary skill having benefit of this disclosure that one or more tool mounts 32, 35, 36 may be located in hand tool portion 48 and that one or more of the various tools, dies or devices of the present invention may be disposed on such tool mount. In a preferred embodiment, a crimping die may be disposed on a tool mount 35 disposed in hand tool portion 48 oriented in-line with the pliers' handles.

While the invention has been described with reference to several preferred embodiments, obvious modifications and alterations are possible by those skilled in the related art having benefit of this disclosure. Therefore, it is intended that the invention include all such modifications and alterations to the full extent that they come within the scope of the following claims or the equivalents thereof.

1. A pliers tool comprising:
a pair of pliers arms each comprising a handle portion at one end thereof and a jaw portion at another end thereof, said arms being pivotally joined together at a point on each arm between their respective jaw and handle portions,
said jaw portions having outer surfaces and opposed complementary gripping surfaces, said jaw portions together defining at least one elongated groove in an outer surface thereof along said complementary gripping surfaces,
wherein said jaw portions further comprise at least a first pair of opposed tool mounts intersecting the groove, one of said pair of tool mounts being disposed on each of said jaw portions, said pair of tool mounts being adapted to operate on an object disposed in said groove when said jaw portions are closed together.

2. A pliers tool according to claim 1, wherein said pair of tool mounts comprises a wire cutting tool.

3. A pliers tool according to claim 1, wherein said pair of tool mounts comprises a wire stripping tool.

4. A pliers tool according to claim 3, wherein the pliers tool is adapted to remove a predetermined length of insulation.

5. A pliers tool according to claim 1, wherein said jaw portions further define a second elongated groove in another outer surface thereof along said complementary gripping surfaces, and wherein said jaw portions further comprise at least a second pair of opposed tool mounts intersecting the groove, one of said second pair of jaws being disposed on each of said jaw portions, said second pair of tool mounts being adapted to operate on an object disposed in said groove when said jaw portions are closed together.

6. A pliers tool according to claim 5, wherein said second pair of tool mounts comprises a wire cutting tool.

7. A pliers tool according to claim 5, wherein said second pair of tool mounts comprises a wire stripping tool.

8. A pliers tool according to claim 7, wherein said first pair of tool mounts comprises a wire stripper, and said first and second pairs of tool mounts are adapted to remove insulation from wire of different sizes.

9. A duckbill pliers tool according to claim 8, wherein each of the jaw portions is tapered toward a tip thereof remote from said pivotal joining point, and wherein at said tips the complementary gripping surfaces of said jaw portions are at least about ¼″ wide.

10. A needle nose pliers tool according to claim 8, wherein each of the jaw portions is tapered toward a tip thereof remote from said pivotal joining point, and wherein at said tips the complementary gripping surfaces of said jaw portions are less than about ¼″ wide.

11. A pliers tool according to claim 1, further comprising at least one wire stripping die disposed in said groove for removing insulation from a wire oriented substantially perpendicular to the groove, said die comprising a portion disposed on each of the jaw portions.

12. A pliers tool according to claim 11, wherein said at least one wire stripping die comprises a plurality of wire stripping dies.

13. A pliers tool according to claim 1, further comprising a bore in at least one of said outer surfaces, said bore adapted to receive an end of a wire, whereby the wire may be bent around a portion of said outer surface to form a loop adjacent said end.

14. A pliers tool according to claim 1, wherein each of said gripping surfaces comprises a notch proximate a tip of said jaw portion, said notch adapted to grasp an object.

15. A pliers tool according to claim 1, further comprising a wire cutter disposed in said jaw portions proximate one of the outer surfaces thereof.

16. A pliers tool according to claim 15, wherein said wire cutter is disposed in said jaw portions proximate the pivotal joining point.

17. A pliers tool according to claim 1, wherein said pliers tool is a long nose pliers tool.

18. A pliers tool according to claim 17, wherein said pliers tool is a needle nose pliers tool.

19. A pliers tool according to claim 17, wherein said pliers tool is a duckbill pliers tool.

20. A pliers tool according to claim 1, wherein at least one of the jaw portions comprises a deburring portion on the outer surface thereof.

21. A pliers tool according to claim 20, wherein said deburring portion comprises a sharpened edge.

22. A pliers tool according to claim 20, wherein said deburring portion comprises a rounded, roughened face.

23. A pliers tool according to claim 1, further comprising a wire stripping die in the jaw portions, said stripping die being adapted to remove an outer insulation sheath of a multi-conductor cable.

24. A pliers tool according to claim 1, wherein the jaw portions further comprise a wire stripping die adapted to remove insulation simultaneously from at least two wires of a multi-conductor cable.

25. A pliers tool according to claim 1, further comprising at least one wire stripping die disposed on an outer surface thereof.

26. A pliers tool according to claim 25, wherein the at least one wire stripping dies comprise half-circle wire stripping die.

27. A long nose pliers comprising:
a pair of pliers arms each comprising a handle portion at one end thereof and a jaw portion at another end thereof, said arms being pivotally joined together at a point on each arm between their respective jaw and handle portions,
said jaw portions having outer surfaces and opposed complementary gripping surfaces, said jaw portions together defining at least one elongated groove in an outer surface thereof along said complementary gripping surfaces, and each of said jaw portions being tapered toward a tip thereof remote from said pivotal joining point;
wherein said jaw portions further comprise at least a first pair of opposed wire strippers intersecting the groove, one of said pair of wire strippers being disposed on each of said jaw portions, said first pair of wire strippers being adapted to remove insulation from a wire disposed in said groove when said jaw portions are closed together.

28. The pliers of claim 27, wherein said jaw portions further define a second elongated groove in another outer surface thereof along said complementary gripping surfaces, wherein said jaw portions further comprise at least a second pair of opposed wire strippers intersecting the second groove, one of said second pair of wire strippers being disposed on each of said jaw portions, and wherein said first and second pairs of wire strippers are adapted to remove insulation from wires of different diameters.

29. The pliers of claim 27, wherein said first pair of tool mounts comprises a wire stripping tool, and said first and second pairs of tool mounts are adapted to remove insulation from wire of different sizes.

30. The pliers of claim 27, further comprising a bore in at least one of said outer surfaces, said bore adapted to receive an end of a wire, whereby the wire may be bent around a portion of said outer surface to form a loop adjacent said end.

31. The pliers of claim 27, wherein each of said gripping surfaces comprises a notch proximate a tip of said jaw portion, said notches being adapted to grasp an object.

32. The pliers of claim 31, wherein the notch is v-shaped.

33. The pliers of claim 31, wherein the notch is rectangular shaped.

34. The pliers of claim 27, wherein the pliers is a duckbill pliers tool the complementary gripping surfaces of said jaw portions are at least about ¼″ wide.

35. The pliers of claim 27, wherein the complementary gripping surfaces of said jaw portions are less than about ¼ wide.

36. The pliers of claim 27, further comprising a wire-stripping die in the jaw portions, said stripping die being adapted to remove an outer insulation sheath of a multi-conductor cable.

37. The pliers of claim 27, wherein the jaw portions further comprise a wire stripping lo die adapted to remove insulation simultaneously from at least two wires of a multi-conductor cable.

38. A long nose pliers tool according to claim 27, further comprising at least one wire stripping die disposed on an outer surface thereof.

39. A pliers tool according to claim 38, wherein the at least one wire stripping dies comprise half-circle wire stripping die.

40. A long nose pliers tool according to claim 27, wherein at least one of the jaw portions comprises a deburring portion on the outer surface thereof.

41. A long nose pliers tool according to claim 40, wherein said deburring portion comprises a sharpened edge.

42. A long nose pliers tool according to claim 40, wherein said deburring portion comprises a rounded, roughened face.

43. A pliers tool comprising:
a pair of pliers arms each comprising a handle portion at one end thereof and a jaw portion at another end thereof, the arms being pivotally joined together at a point on each arm between their respective jaw and handle portions;
wherein the pair of pliers arms comprise an outer surface;
wherein the jaw portions comprise at least a first pair of opposed tool mounts, one of the pair of tool mounts being disposed on each of the jaw portions, the pair of tool mounts being adapted to operate on an object disposed between the tool mounts when the jaw portions are closed together;
wherein the first pair of opposed tool mounts comprise at least one wire stripping tool; and
wherein the first pair of opposed tool mounts are disposed perpendicular to the pair of pliers arms for removing insulation from an insulated electrical wire using a pulling motion.

44. A pliers tool as set forth in claim 43, wherein the pair of pliers arms are shaped in a form defined as side cutting linesman pliers.

45. A pliers tool as set forth in claim 43, wherein the pair of pliers arms are shaped in a form defined as diagonal pliers.

46. A pliers tool as set forth in claim 43, wherein the pair of pliers arms are shaped in a form defined as nipper pliers.

47. A pliers tool as set forth in claim 43, wherein the pair of pliers arms are shaped in a form defined as wire strippers pliers.

48. A pliers tool as set forth in claim 43, wherein the pair of pliers arms further comprise a deburring portion on the outer surface of the jaw portion thereof to remove burrs from inside edges of a pipe.

49. A pliers tool as set forth in claim 48, wherein the deburring portion comprises a sharpened edge.

50. A pliers tool as set forth in claim 48, wherein the deburring portion comprises a rounded, roughened face.

51. A pliers tool as set forth in claim 43, further comprising at least one bore in at least one of the outer surfaces wherein the at least one bore comprises a predetermined diameter and a predetermined depth to allow the wire to be inserted to the predetermined diameter and the predetermined depth and then bent around a portion of the outer surface to form a loop with a twisting motion of the tool or the wire.

52. A pliers tool as set forth in claim 43, further comprising at least one stripping die half-round wire stripping die disposed on the outer surface thereof.

53. A pliers tool according to claim 52, wherein the at least one wire stripping dies comprise half-circle wire stripping die.

54. A pliers tool as set forth in claim 43, wherein the at least one wire stripping tool is configured in the shape of a Romex-type non-metallic 2 conductor wire with ground cable sheath, wherein the at least one wire stripping tool removes the cable sheath without damaging the insulation of the wires inside the multi-conductor wire cable sheath.

55. A pliers tool as set forth in claim 43, wherein the at least one wire stripping tool is configured to allow removing the insulation of multiple same-size wire conductors using a pulling motion.

56. A pliers tool as set forth in claim 54, wherein the at least first wire stripping tool is configured in the shape of the Romex-type non-metallic 2 conductor wire with ground cable sheath, wherein the at least one wire stripping tool removes the cable sheath without damaging the insulation of the wires inside the multi-conductor wire cable sheath and the at least second wire stripping tool is configured to allow removing the insulation of multiple same-size wire conductors using the pulling motion.

57. A pliers tool as set forth in claim 43, further comprising a cutting area in a center area of the jaw portion of the pliers arms wherein the cutting area is parallel with the pliers arms.

58. A pliers tool comprising:
a pair of pliers arms each comprising a handle portion at one end thereof and a jaw portion at another end thereof, the arms being pivotally joined together at a point on each arm between their respective jaw and handle portions;
wherein the pair of pliers arms comprise an outer surface;
wherein a wire stripping tool is disposed on the outer surface of the pliers arms in the proximity of the pivot point and parallel to the pair of pliers arms for removing insulation from an insulated electrical wire using a sideways motion.
